(19) United States
(12) Patent Application Publication
(10) Pub. No.: US 2014/0160534 A1
(43) Pub. Date: Jun. 12, 2014

(54) IMAGE PROCESSING METHOD, IMAGE FORMING APPARATUS AND IMAGE FORMING SYSTEM

(71) Applicant: KONICA MINOLTA, INC., Tokyo (JP)

(72) Inventor: Mitsunori NAKAMURA, Tokyo (JP)

(73) Assignee: KONICA MINOLTA, INC., Tokyo (JP)

(21) Appl. No.: 14/084,395

(22) Filed: Nov. 19, 2013

(30) Foreign Application Priority Data
Dec. 6, 2012 (JP) 2012-266993

(51) Int. Cl. H04N 1/00

(52) U.S. Cl. CPC H04N 1/00795; H04N 1/00278
USPC 358/3.24

(57) ABSTRACT

An image processing method, an image forming apparatus and an image forming system are provided. When a printed image is read to generate data, the amount of data can effectively be reduced. A data acquisition unit acquires the print image data of each page of a reference printed copy as baseline data, and the print image data of each page of a non-reference printed copy. A differential data generating unit 65 then generates differential information by comparing the print image data of the non-reference printed copy with the baseline data for each page. With respect to non-reference printed copy, the amount of data can be reduced by generating differential information than if the print image data is used as it is. Furthermore, one copy is compared with another copy with respect to the same page of the same original so that the similarity and high data compression can be assured.

### CROSS-REFERENCE TO RELATED APPLICATIONS

The present application claims priority under 35 U.S.C. §119 to Japanese Patent Application No. 2012-266993, filed on Dec. 6, 2012. The contents of this application are herein incorporated by reference in their entirety.

### FIELD OF THE INVENTION

The present invention relates to an image processing method, an image forming apparatus and an image forming system.

### DESCRIPTION OF THE RELATED ART

Heretofore, image forming apparatuses such as printers, copying machines and so forth are known as electrophotographic systems. A known image forming apparatus of this type optically reads a print image formed on a sheet to generate print image data therefrom. For example, Japanese Patent Published Application No. 2000-350044 discloses a printed material compression apparatus which can process a printed material consisting of a plurality of pages, and generate image data in the form of data items which can be used to recover the pages respectively. This apparatus encodes the image of the first page of a printed material having a predetermined number of pages, and generate an ordinary compressed data item as compressed data of the first page.

Also, this apparatus generates the differential information between the image data of the P-th page (P=2 through the last page number) and the image data of the (P−1)th page as compressed data of the P-th page, i.e., the differential compressed data of the P-th page containing the positions and data of segments which are different from those of the (P−1)th page. It is described that the size of the data can be made smaller than those of conventional techniques.

However, in accordance with the technique disclosed in Japanese Patent Published Application No. 2000-350044, the amount of data cannot substantially be reduced even by creating the differential information between these pages if there is no correlation between these pages.

The present invention has been made in order to solve the problems as described above. It is an object of the present invention therefore to provide a technique to effectively reduce the amount of data which is generated by reading a printed image.

### SUMMARY OF THE INVENTION

To achieve at least one of the abovementioned objects, an image processing method reflecting one aspect of the present invention comprises: a first step of forming an image on a sheet on the basis of a print job including information about a printed material consisting of a predetermined number of pages and the number of copies to be printed; a second step of reading the image formed on the sheet and generating print image data; a third step of acquiring, as baseline data, print image data of each page of a printed copy which is one of a plurality of the printed copies and to be used as a reference; and a fourth step of acquiring print image data of each page of a printed copy other than the printed copy that is to be used as the reference, comparing the print image data acquired in this fourth step with the baseline data for each page, and generating differential information therebetween.

It is preferred here that the image processing method further comprises: a fifth step of calculating a quality index which is used as an index of the print image quality of a printed sheet on the basis of said differential information; and a sixth step of comparing the calculated quality index with a reference value, and determining if the print image quality of the printed sheet is acceptable.

Also, it is preferred that the image processing method further comprises: a seventh step of performing, when it is determined that the print image quality of the printed sheet is not acceptable, at least one of processes of notifying a user of a warning, cancelling image formation, retrying printing, and performing an image quality stabilization process for maintaining the image quality of image formation to an appropriate level.

Furthermore, it is preferred that the differential information for calculating the quality index in said fifth step is generated by extracting a partial area from the image area corresponding to the print image data.

Furthermore, it is preferred that the resolution of the differential information is changed in said fourth step in accordance with the quality index calculated in said fifth step.

Furthermore, it is preferred that the image processing method further comprises: an eighth step of displaying the differential information.

Furthermore, it is preferred that the differential information is calculated in said fourth step by extracting a partial area from the image area corresponding to the print image data.

Furthermore, it is preferred that said second step includes a step of acquiring printed copy information indicative of information about the printed copy which is the subject of reading operation, and determining whether to read the image on the basis of the acquired printed copy information.

Furthermore, it is preferred that said fourth step includes a step of acquiring printed copy information indicative of information about the printed copy which is the subject of reading operation, and determining whether to generate the differential information on the basis of the acquired printed copy information.

Furthermore, it is preferred that said third step includes a step of storing the acquired baseline data in a storage area, and wherein said fourth step includes a step of storing the generated differential information in a storage area.

Furthermore, it is preferred that said fourth step includes a step of acquiring printed copy information indicative of information about the printed copy which is the subject of reading operation, and determining whether to store the differential information in said storage area on the basis of the acquired printed copy information.

Furthermore, it is preferred that the differential information is stored in said storage area in said fourth step together with identification information which identifies print data, and wherein when it is determined that the print job is a reprint job, the data stored in said storage area is used as the baseline data.

Furthermore, it is preferred that, in the fourth step, the differential information of the printed copies corresponding to each page is stored in one data block, or the differential information corresponding to all the pages of each copy is stored in one data block.

### BRIEF DESCRIPTION OF DRAWINGS

FIG. 1 is a view for schematically showing the configuration of an image forming apparatus in accordance with a first embodiment of the present invention.

FIG. 2 is a block diagram for schematically showing the structure of the control architecture of the image forming apparatus of the first embodiment.

FIG. 3 is a flow chart for showing the process steps performed by the image forming apparatus of the first embodiment.

FIG. 4 is a flowchart for showing the details of a differential information generating process.

FIG. 5 is an explanatory view for showing the scheme of generating the differential information.

FIG. 6 is a schematic diagram for showing formats for storing data which is generated.

FIG. 7 is a schematic diagram for showing formats for storing data which is generated.

FIG. 8 is an explanatory view for showing an example of dividing an image area into small areas.

FIG. 9A through FIG. 9D are explanatory views for showing how to display differential information.

FIG. 10 is a flow chart for showing the steps to be performed when displaying the print image which is read.

### DETAILED DESCRIPTION OF THE PREFERRED EMBODIMENT

### First Embodiment

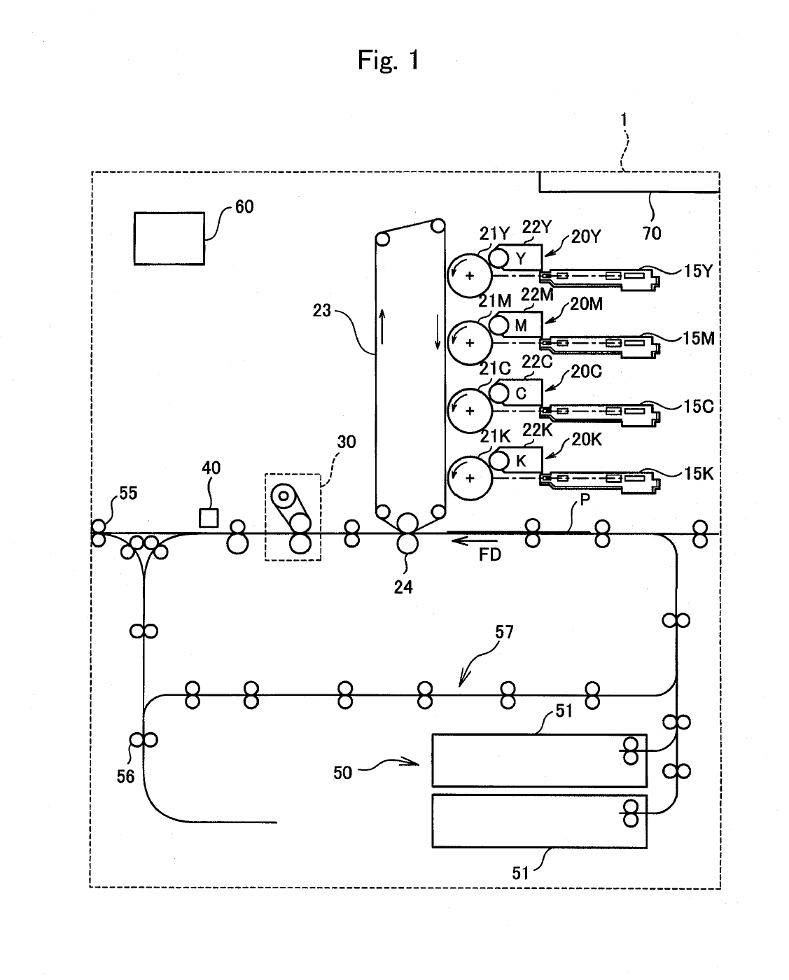

FIG. 1 is a view for schematically showing the configuration of an image forming apparatus 1 according to a first embodiment. The image forming apparatus 1 is, for example, an electrophotographic image forming apparatus called a tandem color image forming apparatus which includes a plurality of photoreceptor drums vertically arranged in contact with one intermediate transfer belt to form full-color images.

The image forming apparatus 1 consists mainly of an original reading unit which is not shown in the figure, exposure units 15Y, 15M, 15C and 15K, charging/developing units 20Y, 20M, 20C and 20K, an intermediate transfer belt 23, a fixing unit 30, a print image reading unit 40 and a control unit 60, which are installed within one housing.

The original reading unit includes an automatic document feeder (not shown in the figure) installed on the top of the original reading unit, and reads the image of each original fed by the automatic document feeder to obtain image signals. The image signals are output to an image reading control unit (not shown in the figure) which processes the image signals by performing A/D conversion, shading compensation, data compression and so on, and outputs the processed signals to the control unit 60 as print data. Incidentally, the print data input to the control unit 60 is not limited to the print data as read by the original reading unit, but can be the data, for example, as received from another image forming apparatus, a personal computer or the like connected to the image forming apparatus.

Each of the exposure units 15Y to 15K includes a laser source, a polygon mirror, a plurality of lenses and so on. The exposure units 15Y to 15K scans and exposes the surfaces of the photoreceptor drums 21Y, 21M, 21C and 21K respectively with laser beams in correspondence with the output information which is output from the control unit 60 on the basis of the print data.

The charging/developing unit 20Y consists mainly of the photoreceptor drum 21Y and a charging/developing device 22Y which is located near the periphery of the photoreceptor drum 21Y, and forms an image corresponding to yellow on the photoreceptor drum 21Y. The other charging/developing units 20M, 20C and 20K have the similar structure as the charging/developing unit 20Y, and have charging/developing devices 22M, 22C and 22K near the peripheries of the photoreceptor drums 21M, 21C and 21K respectively to form images corresponding to magenta, cyan and black on the photoreceptor drums 21M, 21C and 21K respectively.

The photoreceptor drums 21Y, 21M, 21C and 21K are uniformly charged with electricity by the charging/developing devices 22Y, 22M, 22C and 22K to form latent images on the photoreceptor drums 21Y, 21M, 21C and 21K respectively by a scanning exposure process with the exposure units 15Y, 15M, 15C and 15K as described above. The charging/developing devices 22Y, 22M, 22C and 22K then make visible the latent images on the photoreceptor drums 21Y, 21M, 21C and 21K by developing the images with toners. By this process, images (toner images) are formed on the photoreceptor drums 21Y, 21M, 21C and 21K respectively. The images formed on the photoreceptor drums 21Y, 21M, 21C and 21K are successively transferred to a predetermined location of the intermediate transfer belt 23 and superimposed as color components respectively to form a color image.

The image transferred to the intermediate transfer belt 23 is then transferred to a sheet P, which is conveyed with a predetermined timing, through transfer rollers 24.

The paper feed unit 50 includes one or more paper feed trays 51, each of which stores sheets P. This paper feed unit 50 feeds sheets P selected by a user from the paper feed tray 51 one by one. The sheet P fed from the paper feed tray 51 is conveyed through conveyance rollers and supplied to a transfer site where the image is transferred to the sheet P by the transfer rollers 24, and then supplied to a fixing unit 30.

The fixing unit 30 is a device which performs a fixing process for fixing an unfixed image to a sheet P, and consists for example of a pair of fixing members which are in contact with each other under pressure and a heater for heating either or both of the fixing members. This fixing unit 30 fixes an image to a sheet P under the pressure and heat applied at a nip site between the pair of fixing members by passing the sheet P through the nip site during the conveyance of the sheet P. The sheet P with the fixed image is conveyed to the downstream side in the conveying direction.

Incidentally, the above elements, i.e., the exposure units 15Y, 15M, 15C and 15K, the charging/developing units 20Y, 21M, 21C and 21K, the intermediate transfer belt 23, the transfer rollers 24, and the fixing unit 30 function as an image forming unit in combination. That is to say, the image forming unit forms an image on a sheet P by a series of steps of (1) forming an image, (2) transferring the formed image to the sheet P, (3) fixing the transferred image to the sheet P.

The print image reading unit 40 is installed on the conveying route of the sheet P to read an image formed on the sheet P (printed sheet) passed through the conveying route. For example, the print image reading unit 40 includes a line sensor consisting of a plurality of imaging devices which are capable of performing photoelectric conversion for each picture element respectively and one-dimensionally arranged in the direction perpendicular to the sheet conveyance direction (the sheet width direction) to read the image of a printed sheet (print image) on a line-by-line basis in the sheet width direction. The print image reading unit 40 read the print image of a printed sheet which is output from the fixing unit 30 to generate print image data. After generating the print image data corresponding to one side of a sheet P, the print image reading unit 40 outputs this data to the control unit 60.

The sheet P passed through the print image reading unit 40 is discharged by a discharging roller 55 to a catch tray (not shown in the figure) attached to the external side of the housing. On the other hand, when an image is to be formed also on the back side of the sheet P, the sheet P with the image formed on the front side is conveyed to reversing rollers 56 located below by a guide member (not shown in the figure). The reversing rollers 56 hold the tail end of the sheet P which is conveyed therebetween and then reverse the sheet P by sending back it to a refeeding conveyance route 57. This refeeding conveying route 57 conveys the reversed sheet P to the transfer rollers 24 again.

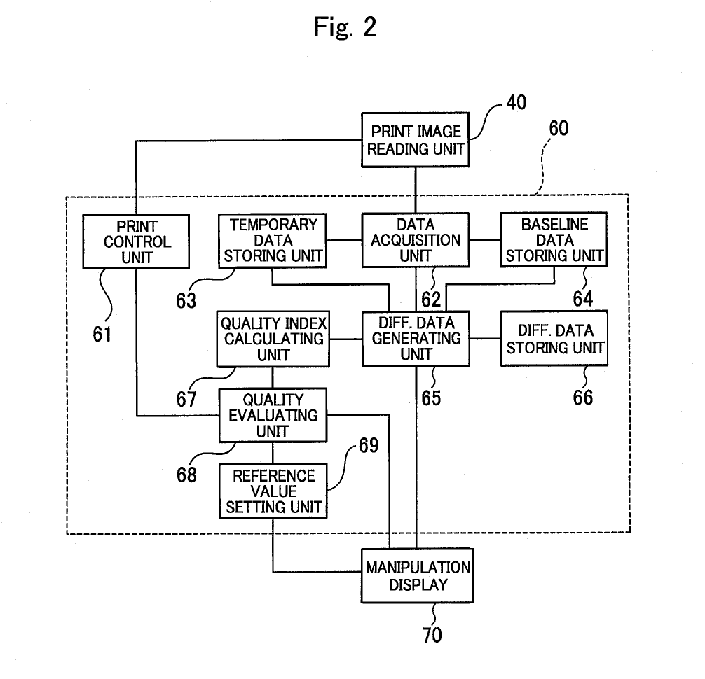

FIG. 2 is a block diagram for schematically showing the structure of the control architecture of the image forming apparatus 1. The control unit 60 is responsible for integrally controlling the image forming apparatus 1. For example, the control unit 60 can be implemented with a computer provided with a CPU, memories such as a ROM and a RAM, an HDD (Hard Disk Drive) as an auxiliary storage device, and a communication I/F, which are connected with each other through a bus. As seen from a functional view point, the control unit 60 serves as a print control unit 61, a data acquisition unit 62, a temporary data storing unit 63, a baseline data storing unit 64, a differential data generating unit 65, a differential data storing unit 66, a quality index calculating unit 67, a quality evaluating unit 68, and a reference value setting unit 69.

The print control unit 61 forms an image on a sheet P by controlling the original reading unit, the exposure units 15Y, 15M, 15C and 15K, the charging/developing units 20Y, 20M, 20C and 20K, the intermediate transfer belt 23, the fixing unit 30 and so forth. In other words, the print control unit 61 forms an image on a sheet P on the basis of a print job. A print job contains information about a printed material comprising a predetermined pages, and the number of print copies to be printed of that material. Also, a print job contains information about printing conditions, for example, the mode of single/double-side printing, the density and reduce/enlarge ratio of images, and the type of sheets P (for example, paper density), and so forth.

The data acquisition unit 62 acquires the print image data of each page of a printed copy from the print image reading unit 40. While proceeding with execution of a print job, print image data is acquired for each page through the data acquisition unit 62 every time when printing a copy of the printed material. The acquired print image data is stored in the temporary data storing unit 63.

When the acquired print image data corresponds to a copy of the printed material (hereinafter referred to as the reference printed copy), to be used as the base copy, from among a plurality of printed copies of the printed material, for example the first copy, the data acquisition unit 62 stores this acquired print image data as baseline data in the baseline data storing unit 64. The baseline data storing unit 64 therefore stores baseline data (print image data) of each page corresponding to the reference printed copy.

The differential data generating unit 65 generates differential image data of a printed sheet (non-reference printed copy) other than the reference printed copy as differential information by comparing the print image data of the non-reference printed copy with the baseline data corresponding thereto for each page. In this case, the differential image data is information which is two-dimensionally obtained by calculating the difference in brightness between the print image data of the non-reference printed copy and the baseline data (the print image data of the reference printed copy) at each picture element. The differential image data is generated for each page of the non-reference printed copy and stored in the differential data storing unit 66 as the differential image data of this page.

The quality index calculating unit 67, the quality evaluating unit 68 and the reference value setting unit 69 are units for judging the quality of a printed copy as explained in the description of a second embodiment to be described below in detail. Because of this, these units can be dispensed with in the case of the first embodiment.

The manipulation display 70 is for example a touch panel through which users can input setting information with reference to the information displayed on the panel. The manipulation display 70 outputs several items of information to the control unit 60 in accordance with input operations by users. Furthermore, the manipulation display 70 is controlled by the control unit 60 to display and provide appropriate information to users.

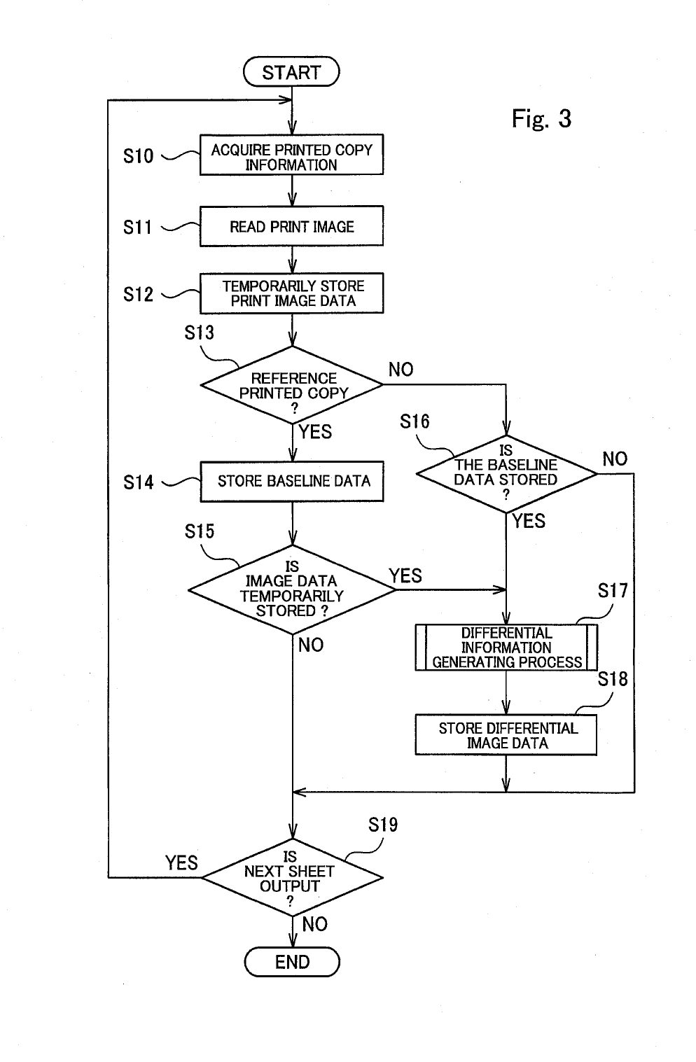

FIG. 3 is a flow chart for showing the procedure of the operation of the image forming apparatus 1 in accordance with the present embodiment. The process based on this flow chart is called in response to the input of a job as a trigger.

First, in step 10 (S10), the print image reading unit 40 acquires printed copy information from the print control unit 61 to read an image (print image) formed on a sheet P (printed sheet). The printed copy information is information about a printed sheet to be read, and contains the copy number, page number, total number of pages of one copy, paper size, color/monochrome printing mode and so on of the printed sheet. In the following description, it is assumed that the printed sheet is the N-th page of the M-th copy.

Alternatively, the print image reading unit 40 can acquire the printed copy information from a barcode or the like printed on the printed sheet and containing the printed copy information which is read during reading the print image.

In step 11 (S11), the print image reading unit 40 reads the print image of the printed sheet and generates the print image data containing one-page information. The print image reading unit 40 associates the print image data with page information and copy information, and outputs the information to the data acquisition unit 62.

Alternatively, the print image reading unit 40 can acquire the printed copy information by counting up the current copy number and page number by itself, rather than from the print control unit 61. However, a double-side printing job is often performed by alternately forming front and back sides for the purpose of improving the productivity. In such a case, the order of reading sheets may not accord with the order of pages. It is thereby preferred to use the printed copy information acquired from the print control unit 61.

Also, the print image reading unit 40 may change the reading resolution in accordance with the type of the sheet P. A standard sheet having a smaller thickness is conveyed at a faster line speed so that the image thereon can be read only at a lower resolution. Contrary to this, a thicker sheet is conveyed at a lower line speed so that the image thereon can be read at a higher resolution. Furthermore, the reading resolution may be changed in accordance with the free space and/or writing speed of the storage. Still further, in the case where a plurality of pages are printed within one sheet, the print image data which is read may be divided corresponding to each page to generate a separate print image data item for each page.

In step 12 (S12), the data acquisition unit 62 acquires the print image data, the page information and the copy information from the print image reading unit 40. The data acquisition unit 62 stores the page information and the copy information in association with the print image data in the temporary data storing unit 63. In this case, it is desired to provide the buffer size of the temporary data storing unit 63 sufficient to store the number of pages corresponding to the number of sheets which is circulating after front side printing for back side printing.

In step 13 (S13), the data acquisition unit 62 determines whether or not the printed sheet, which is just read, is a sheet of a reference printed copy on the basis of the copy information of the print image data. It is determined in advance which copy is to be used as the reference printed copy. For example, the first copy is appropriate for the reference printed copy. However, the reference printed copy is not necessarily the first copy. For example, a particular X-th copy may be used as the reference printed copy after the image formation might become stable. In such a case, the first through (X−1)th copies have to be stored in the temporary data storing unit 63 and then used to perform a differential information generating process, to be described below, with the image data of the reference printed copy which is to be subsequently read.

If the determination is in the affirmative in step 13, the process proceeds to step 14 (S14). Conversely, if the determination is in the negative in step 13, the process proceeds to step 16 (S16).

In step 14, the data acquisition unit 62 stores the acquired print image data in the baseline data storing unit 64 as baseline data. The baseline data contains not only the print image data but also the page information and the copy information in association with the print image data. When the baseline data is stored, the data acquisition unit 62 performs a data compression process for the purpose of reducing the data size. The data compression process is preferably performed as lossless compression such as run-length encoding which does not degrade the image quality. After the baseline data is completely stored, the data acquisition unit 62 sets a read completion flag to indicate that the image of the N-th page has completely been read. The read completion flag is provided one for every one page of the printed material.

Incidentally, the baseline data is not necessarily print image data which is prepared by reading a reference printed copy. For example, the baseline data can also be generated by calculating the average or median value for each picture element of the print image data of a plurality of printed copies.

In step 15 (S15), the data acquisition unit 62 determines whether or not the temporary data storing unit 63 stores the print image data of the N-th page of a printed copy other than the reference printed copy, i.e., a non-reference printed copy. If the determination is in the negative in step 15, the process proceeds to step 19 (S19) to be described below. Conversely, if the determination is in the affirmative in step 15, the process proceeds to step 17 (S17) to be described below.

In step 16, the data acquisition unit 62 determines whether or not the temporary data storing unit 63 stores the baseline data corresponding to the N-th page, i.e., the print image data of the N-th page of the reference printed copy. If the determination is in the affirmative in step 16, the process proceeds to step 17. Conversely, if the determination is in the negative in step 16, the process proceeds to step 19.

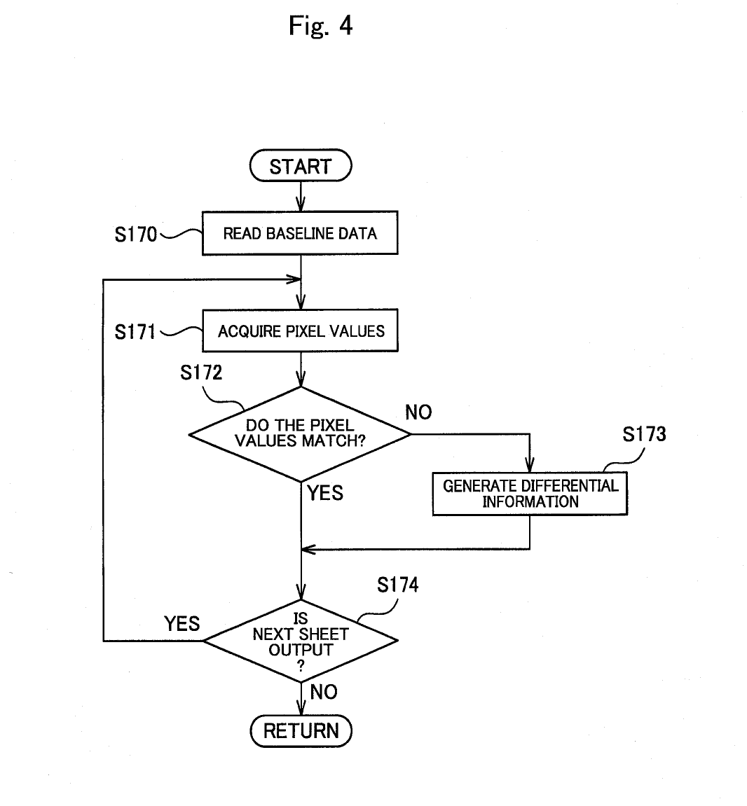

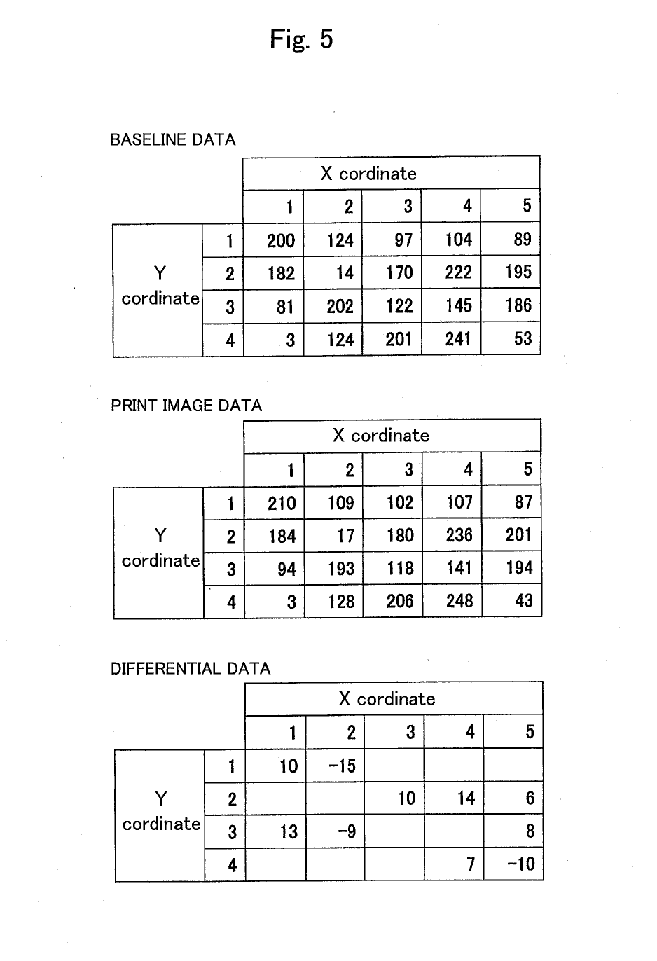

In step 17, the differential data generating unit 65 performs the differential information generating process. FIG. 4 is a flow chart for showing the details of the differential information generating process, and FIG. 5 is an explanatory view for showing the scheme of generating the differential information. First, in step 170 (S170), the differential data generating unit 65 reads the baseline data of the N-th page from the baseline data storing unit 64, and reads the print image data of the N-th page of the M-th copy from the temporary data storing unit 63.

In step 171 (S171), the differential data generating unit 65 acquires the data item (pixel value) from the read baseline data and the data item from the read print image data respectively corresponding to one picture element.

In step 172 (S172), the differential data generating unit 65 determines whether or not the acquired two pixel values match. In this case, it may be determined that these pixel values match each other not only when these values are exactly equal to each other but also when the difference therebetween is smaller than a predetermined value. This is because there occur reading errors due to noise in the print image reading unit 40 and displacement in reading position due to variation of the speed of conveying a sheet P, so that it is desirable to determine that these values match if the difference therebetween is small.

If the determination is in the negative in step 172, the process proceeds to step 173 (S173). Conversely, if the determination is in the affirmative in step 172, the process proceeds to step 174 (S174).

In step 173, the differential data generating unit 65 associates the difference in pixel value between the baseline data and the print image data with the position of the picture element which is currently processed, and outputs the difference as differential image data (differential information) corresponding to that picture element. Alternatively, the differential data generating unit 65 may output, in place of the differential pixel value, the pixel value and position of the picture element which is currently processed as differential image data.

In step 174, the differential data generating unit 65 determines whether or not there is a next unprocessed pixel. If the determination is in the affirmative in step 174, the process is returned to step 171. Conversely, if the determination is in the negative in step 174, i.e., if the differential image data corresponding to one page is completely generated, this routine returns control.

Meanwhile, in step 17, the differential data generating unit 65 may perform parallel displacement and/or rotation of the print image data to align the print image data with the baseline data in advance of generating differential image data. In this case, preferably, the amounts of displacement and/or rotation are stored as part of the differential image data.

Also, the differential data generating unit 65 may display the differential image data generated of one page on the manipulation display 70. Particularly, it is possible to helps a user to get an overview of the differences by displaying differential image data in which the picture elements having greater differential brightnesses are emphasized.

On the other hand, in the case where the X-th copy (X≠1) is designated as the reference printed copy, the temporary data storing unit 63 has stored the print image data of the N-th page of each of the first through (X−1)th copies before handling the X-th copy. In this case, after reading the print image of the N-th page of the X-th copy, the differential information generating process is performed for each of the first through (X−1)th copies.

In step 18 (S18), the differential data generating unit 65 stores the generated differential image data in the differential data storing unit 66 together with the page information and the copy information. The differential data generating unit 65 may compress the differential image data before storing the differential image data. Furthermore, the differential data generating unit 65 deletes the print image data, with which the differential image data has been generated, from the temporary data storing unit 63.

Then, in step 19, the print image reading unit 40 interrogates the print control unit 61 to determine whether or not the fixing unit 30 outputs a next sheet. If the determination is in the affirmative in step 19, the process is returned to step 10. Conversely, if the determination is in the negative in step 19, the data acquisition unit 62 deletes the print image data corresponding to the baseline data from the temporary data storing unit 63, followed by finishing this routine.

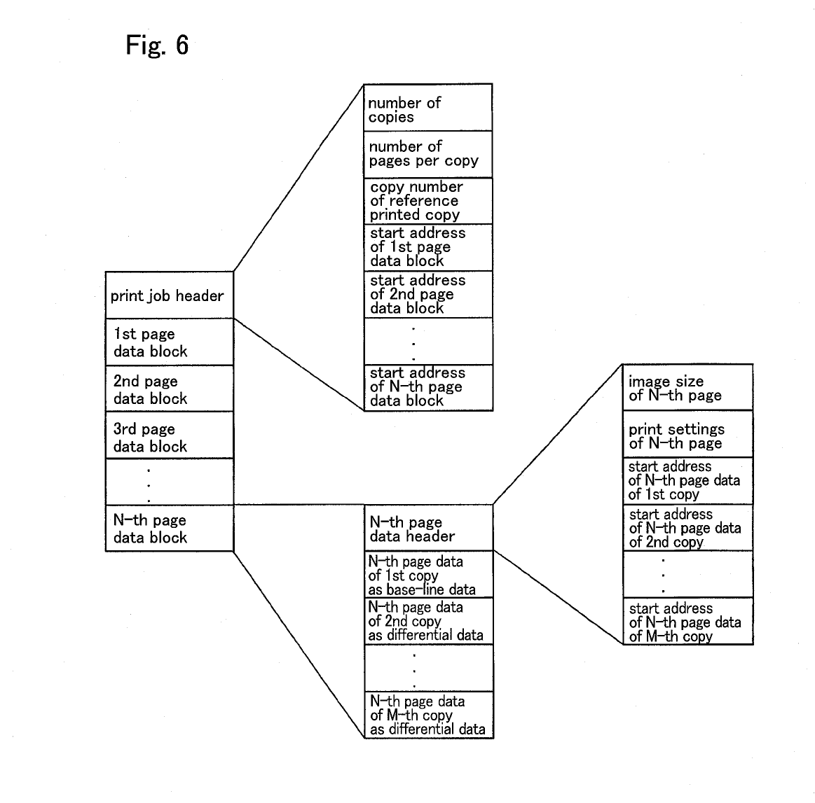

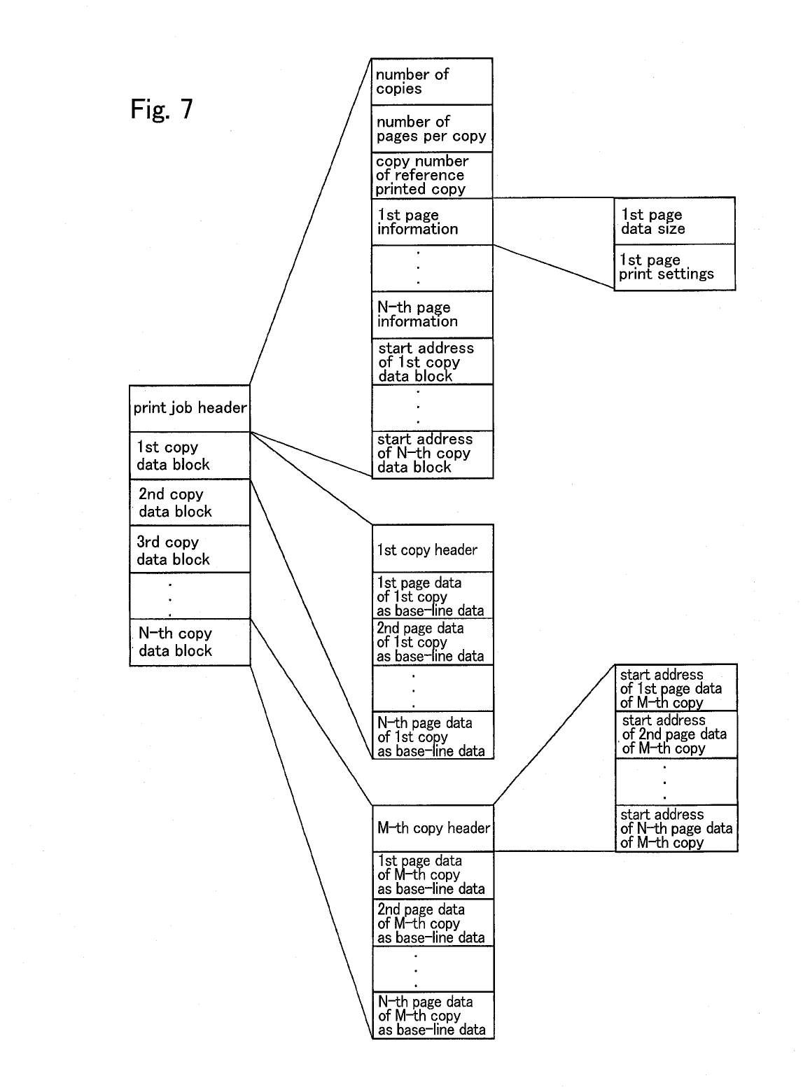

FIG. 6 and FIG. 7 are schematic diagrams for showing formats for storing data which is generated. The series of steps as described above are performed to generate data relating to printed copies for each print job. FIG. 6 shows a data format in which the print image data is stored on a page base, and FIG. 7 shows a data format in which the print image data is stored on a copy base.

First, the format in which the print image data is stored on a page base will be explained. In this case, sorting printout is selected, i.e., after one copy has been printed out, the next copy is printed out from the first page.

This print image data consists of a print job header, a first page data block, a second page data block, . . . , an N-th page data block. First, the data acquisition unit 62 writes print job information as the print job header of the print image data. This print job header includes the number of copies, the number of pages per copy, the copy number of the reference printed copy, and the start address of each page data block.

Also, for each page, the data acquisition unit 62 writes page information as a page header placed at the beginning of each page data block. Specifically, the data acquisition unit 62 stores, in the page header of each page data block, the size of the print image data stored therein, print settings such as the density of images, and the start address of the page data of each copy corresponding to this page. In this case, the data to be stored as the page data is baseline data if the copy is the reference printed copy, and differential image data if the copy is a non-reference printed copy.

When starting the print job, the data acquisition unit 62 writes the print job header first. The start address of each page data block which is not obtained yet is initialized to an appropriate value (for example, 0) in advance. If the page to be next read corresponds to the first copy, the data acquisition unit 62 writes a page header containing page information, and initializes the start address of the page data of each copy, which is not obtained yet, to an appropriate value. Each time one page is read, the data acquisition unit 62 compresses the read data, appends the compressed data to the end of file, and writes the start address of the appended data in the page header corresponding to that page. The data is accumulated by repeating this routine.

In accordance with this data format in which the print image data is stored on a page base, there is the advantage that users can successively compare and confirm the copies with respect to the same page within a shorter time.

Next, the format in which the print image data is stored on a copy base will be explained. This print image data consists of a print job header, a first copy data block, a second copy data block, . . . , an M-th copy data block.

First, the data acquisition unit 62 writes print job information as the print job header of the print image data. The number of copies and the number of pages per copy are known when starting the print job, so that the data acquisition unit 62 can determine the size of the print job header. The data acquisition unit 62 writes, in the print job header, the number of copies, the number of pages per copy, the copy number of the reference printed copy, the page information and the start address of the print image data of each copy. The page information contains the size of the print image data and print settings of each page.

Also, for each copy, the data acquisition unit 62 writes copy information as a copy header placed at the beginning of the copy data block corresponding to this page. The copy header contains the start address of each page data. The page data of the copy is appended for each page to the end of the copy header. In this case, the data to be stored as the page data is baseline data if the copy is the reference printed copy, and differential image data if the copy is a non-reference printed copy.

When starting the print job, the data acquisition unit 62 writes the print job header first. The start address of each copy data block which is not obtained yet is initialized to an appropriate value (for example, 0) in advance. If the page to be read next is the first page, the data acquisition unit 62 determines that the copy is switched, writes copy information as the header of this copy and initializes the start address of each page data, which is not obtained yet, to an appropriate value. Each time one page is read, the data acquisition unit 62 compresses the read data, appends the compressed data to the end of file, and writes the start address of the appended data corresponding to that page in the copy header. The data is accumulated by repeating this routine.

In accordance with this scheme, it is possible to write page data sequentially from the beginning of a file in the order of reading of pages of a printed copy so that the data is hardly fragmented when writing the data in the storage. On the other hand, in the case of double-side printing, the order of reading does not necessarily match the order of pages. Data fragmentation in the storage can be avoided by preparing a buffer sufficient to store the number of pages corresponding to the number of sheets which is circulating after front side printing for back side printing, and writing the print image data of the page after both the sides of this page are read.

In the case of the present embodiment as described above, the data acquisition unit 62 acquires the print image data of each page of the reference printed copy as the baseline data, and the print image data of each page of a non-reference printed copy. The differential data generating unit 65 then generates differential information by comparing the print image data of a non-reference printed copy with the baseline data for each page.

In accordance with this configuration, with respect to non-reference printed copies, the amount of data can be reduced by generating differential information than if the print image data is used as it is. In addition, one copy is compared with another copy with respect to the same page of the same original so that the similarity is assured to enable effective data amount reduction.

Incidentally, the print image data as read is not necessarily stored in whole. Namely, the amount of data can be reduced by not saving the image data corresponding to the area that need not be stored, for example, an area to be cut by a post-printing process, a marginal area in which no data is provided by the print data when the sheet to be printed is wider than the area corresponding to the print data, or the like area. Likewise, not only when storing data, but also when calculating differential information or reading print image data, only part of the image area corresponding to print image data may be processed.

Also, when storing differential image data, the differential data generating unit 65 may generate an electronic signature of the data to detect falsification, and/or encrypt the data against eavesdroppers.

Furthermore, while the differential information generating process is performed each time after reading the print image of one page in accordance with the present embodiment, the differential information generating process can be performed after completing reading the print image data of all the pages of one copy.

### Second Embodiment

In what follows, an image forming apparatus 1 according to the second embodiment will be explained. The image forming apparatus 1 of the second embodiment differs from that of the first embodiment in that the quality of print image is evaluated on the basis of differential information. Meanwhile, the second embodiment will be explained mainly with respect to the differences from the first embodiment without repeating redundant description.

The evaluation of print image quality is performed by the quality index calculating unit 67, the quality evaluating unit 68 and the reference value setting unit 69. Incidentally, the evaluation of print image quality is performed after the differential information generating process (the step 17 of the first embodiment) and before storing differential image data (the step 18 of the first embodiment).

Specifically, the quality index calculating unit 67 acquires differential image data from the differential data generating unit 65, and calculates a quality index on the basis of the differential image data. The quality index is a parameter which indicates the index of the print image quality of the current printed sheet and indicates the similarity between the print image of a non-reference printed copy and the print image of the reference printed copy. This quality index can be defined as a value calculated by accumulating the absolute values of the differential values of picture elements and normalizing the accumulated value with the number of picture elements. If the gradation levels of print images are represented by 8-bit values, the quality index takes a number from 0 to 255. The closer to 0 the quality index is, the smaller the difference of the print image is, i.e., the better the print image quality is. The calculated quality index is output to the quality evaluating unit 68.

Meanwhile, when calculating the quality index, the quality index calculating unit 67 may divide the image area corresponding to differential image data into a plurality of small areas, and calculate a quality index individually for each small area. Alternatively, the quality index calculating unit 67 may extract some of the small areas and calculate a quality index from the extracted small areas.

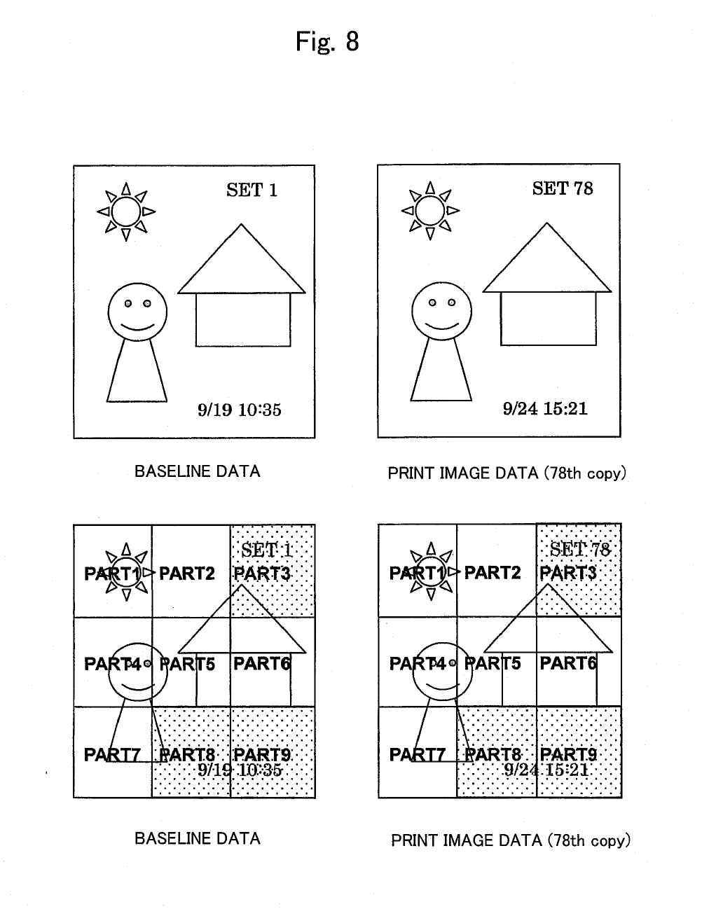

FIG. 8 is an explanatory view for showing an example of dividing an image area into small areas. For example, in the case where a plurality of copies are printed, the copy number (area PART 3) and the print date/time (areas PART 8 and PART 9) are sometimes printed on each sheet of each copy. In such a case, the print control unit 61 may output printed copy information together with information about these areas, and the quality index calculating unit 67 can exclude these areas from the subject of processing.

When printing such copy numbers, print dates/times, serial numbers or the like on an area of a sheet, when printing addresses on post cards or when printing different items in the same format, it is known in advance that the printed copies include different images in the areas where these items are printed. If these areas were processed to calculate the quality index, the quality of printed copies is lowered and thereby cannot be evaluated correctly. Because of this, it is desirable to exclude these areas from the subject of quality evaluation. Which area is to be excluded can be set up, for example, in the print settings.

The quality evaluating unit 68 acquires a quality index from the quality index calculating unit 67, and a quality reference value from the reference value setting unit 69 for judging the quality of printing. If the quality index of the print image on a printed copy is lower than the quality reference value, the quality evaluating unit 68 determines that the print image quality of the printed copy is good. Conversely, if the quality index of the print image on a printed copy is no lower than the quality reference value, the quality evaluating unit 68 determines that the print image quality of the printed copy is bad. If the print image quality is good, the quality evaluating unit 68 requests the differential data generating unit 65 to save the differential image data (the step 18 of the first embodiment). Conversely, if the print image quality is bad, the quality evaluating unit 68 notifies the print control unit 61 of the result of determination.

The quality reference value provided by the reference value setting unit 69 may be a fixed value, or may be an arbitrary value which can be set by a user through the manipulation display 70. Alternatively, the quality reference value may be dynamically changed in accordance with the print progress. For example, the quality reference value may be relaxed as copy printing is repeated. The results of evaluation may be ranked into multiple levels, for example, “good”, “passable” and “bad”.

When the result of evaluation is “bad”, the print control unit 61 performs, for example, the following error handling.

[Notification to Users]

If the result of evaluating a printed sheet is “bad”, the process of forming an image is temporarily stopped. The print control unit 61 then notifies a user of a warning through the manipulation display 70. Also, the print control unit 61 prompts the user to select whether or not the print process is continued through the manipulation display 70. In this case, preferably, the print control unit 61 helps a user to confirm the cause of damaging or wrinkling the printed sheet by displaying differential image data in which the picture elements having greater differential brightnesses are emphasized.

[Cancelling Print Cancellation]

If the result of evaluating a printed sheet is “bad”, the process of forming an image is cancelled.

[Repeating Print Process]

If the result of evaluating a printed sheet is “bad”, the page corresponding to the bad printing is printed again. In this case, preferably, the print control unit 61 prompts the user to select whether to print the page again through the manipulation display 70. However, if the evaluation result of “bad” is repeated even repeating the print process of that page, the print control unit 61 may cancel the print process.

[Adjusting Image Quality]

If the result of evaluating a printed sheet is not acceptable, the print control unit 61 performs an image quality stabilization process, i.e., adjusts the image quality by performing calibration of the image forming apparatus 1 in order to maintain the image quality to an appropriate level. In this case, preferably, the print control unit 61 prompts the user to select whether to perform calibration through the manipulation display 70. Meanwhile, if the evaluation result of “bad” is repeated even repeating calibration, the print control unit 61 may cancel the print process due to machinery failure.

In accordance with the present embodiment as described above, the quality index calculating unit 67 calculates the quality index of a printed sheet on the basis of differential image data. Then, the quality evaluating unit 68 evaluates whether the print image quality of the printed sheet is good or bad by comparing the quality index with the reference value.

In accordance with this configuration, while reducing the amount of data by generating differential image data, the print image quality of a printed sheet can be evaluated with reference to the differential image data.

Furthermore, in accordance with the present embodiment, error handling is performed to deal properly with bad printing.

Incidentally, in accordance with the present embodiment, the quality index may be calculated by extracting a partial area from the image area corresponding to the print image data. In accordance with this configuration, it is possible to exclude, from quality index calculation, such an area which is known in advance as having no assured similarity, and avoid such an undesirable situation that a lower quality index is calculated for a print image having a good quality.

Furthermore, the calculation and evaluation of the print image quality may not be performed when reading a printed sheet, but may be performed thereafter by temporarily saving the print image data. For example, when a user confirms a print image later after reading, the print image quality is then calculated and evaluated while the print image is displayed. This procedure can reduce the processing time by performing calculation and evaluation only when required. In this case, the differential image data is stored in the differential data storing unit 66 together with necessary information such as areas to be used for evaluating a print image quality.

In this case, the differential image data of a print image which is read may be displayed on the manipulation display 70 after processing the data as follows.

(1) Distinguishably Displaying the Amplitude of the Difference at Each Picture Element.

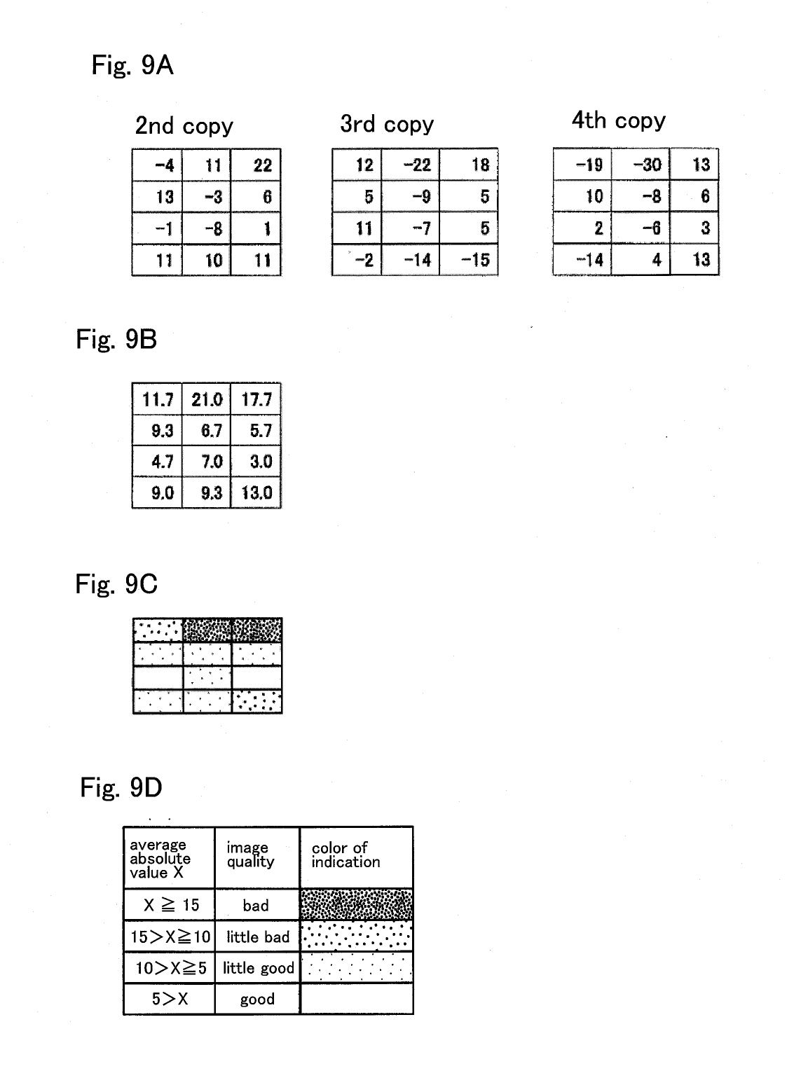

The absolute value of the differential image data (refer to FIG. 9A) is accumulated from the first copy to the last copy for each picture element in the N-th page, and the average value of each picture element is obtained by dividing the accumulated total value by the number of copies (refer to FIG. 9B). It becomes apparent in which area the amplitude of the difference is large, i.e., the print image quality is low. If the differential image data is displayed in order to discriminate the picture elements in accordance with the ranges of the average values, for example, by color coding, adding marks or boxes to emphasize the differences (refer to FIG. 9C and FIG. 9D), users can easily find an area in which the print image quality is low. Incidentally, the average value may be calculated by averaging the differential image data within an area consisting of several picture elements rather than averaging the differential image data for each picture element.

(2) Successively Displaying

The same page may be successively displayed by switching the copy at predetermined intervals. It is therefore possible to display the differential image data in such a manner that a user can easily recognize the differences.

### Third Embodiment

In what follows, an image forming apparatus 1 according to the third embodiment will be explained. The feature of the image forming apparatus 1 of the third embodiment resides in that the quality of print image is evaluated on the basis of differential information in the same manner as that of the second embodiment. Meanwhile, the third embodiment will be explained mainly with respect to the differences from the second embodiment without repeating redundant description.

When a printed sheet is determined as being bad, a user is likely to confirm the print image data later for the purpose of seeking the cause of degrading the print image quality. On the other hand, when a printed sheet is determined as being good, a user is likely not to confirm the print image data thereafter. Hence, the amount of data can be reduced without practical disadvantages by storing the print image data at a high resolution only for printed sheets which are determined as being bad, but storing the print image data at a low resolution for printed sheets which are determined as being good.

The data acquisition unit 62 generates the low resolution print image data from the high resolution print image data output from the print image reading unit 40. The data acquisition unit 62 then stores the low resolution print image data and the high resolution print image data in the temporary data storing unit 63. For example, if the resolution of the high resolution print image data is 600 dpi, the data acquisition unit 62 generates 300 dpi print image data as the low resolution print image data (the step 12 of the first embodiment).

When the printed sheet which is read is a page of the reference printed copy, the data acquisition unit 62 stores the high resolution print image data as baseline data in the baseline data storing unit 64 together with page information (the step 14 of the first embodiment). Incidentally, since the low resolution print image data can be generated from the high resolution print image data, only the high resolution print image data may be stored as baseline data.

The differential data generating unit 65 reads, from the temporary data storing unit 63, the baseline data corresponding to the N-th page of the reference printed copy and the print image data corresponding to the N-th page of the M-th copy, and calculates differential image data. The differential image data is calculated for each of the high resolution print image data and the low resolution print image data.

The quality index calculating unit 67 acquires the differential image data between the baseline data and the print image data at the high resolution from the differential data generating unit 65. The quality index calculating unit 67 then calculates the quality index of the current printed sheet from the differential image data. The calculated quality index is output to the quality evaluating unit 68 which then evaluates the print image quality of the print image.

When notified from the quality evaluating unit 68 that the print image quality is good, the differential data generating unit 65 stores the low resolution print image data in the differential data storing unit 66 together with page information. On the other hand, when notified that the print image quality is bad, the differential data generating unit 65 stores the high resolution print image data in the differential data storing unit 66 together with page information. Incidentally, the page information includes the resolution of the differential image data to be stored.

In accordance with the present embodiment as described above, the differential data generating unit 65 switches the resolution of differential image data in accordance with the quality index that is calculated.

In accordance with this configuration, the resolution of differential image data can be lowered if appropriate. It is therefore possible to effectively reduce the amount of data.

Meanwhile, as described in the second embodiment, the quality index calculating unit 67 may divide the print image which is read into a plurality of areas in each of which the quality index is calculated to evaluate the print image quality for each area. In this case, the differential data generating unit 65 can select the resolution for storing the differential image data in each area on the basis of the print image quality evaluated in this each area. Also, the print image data and the differential image data may be generated at a low resolution on the basis of the evaluation result by the quality evaluating unit 68. In this case, it is possible to omit the unnecessary differential information generating process of the low resolution print image data.

The present embodiment makes use of only two resolutions. However, the resolution may be selected from among three or more resolutions in accordance with the print image quality. In the case where the differential image data is compressed by a lossy compression algorithm, the compression ratio (image quality) may be changed, when storing the differential image data, in accordance with the evaluation result by the quality evaluating unit 68 to reduce the amount of data.

### Fourth Embodiment

In what follows, an image forming apparatus 1 according to the fourth embodiment will be explained. The image forming apparatus 1 of the fourth embodiment differs from that of the first embodiment in that the quality of print image is evaluated when displaying the print image which is read. Meanwhile, this embodiment will be explained mainly with respect to the differences from the second embodiment without repeating redundant description.

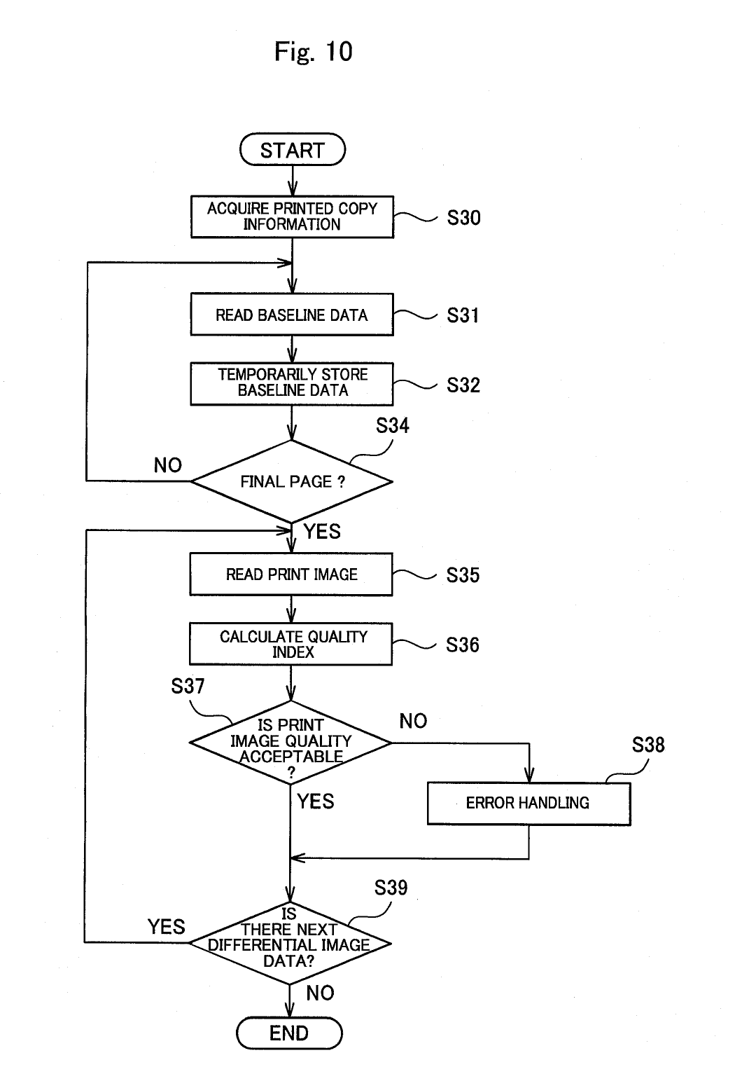

FIG. 10 is a flow chart for showing the steps to be performed when displaying the print image which is read. First, in step 30(S30), the data acquisition unit 62 reads printed copy information from the baseline data stored in the baseline data storing unit 64, and acquires the number of copies, the number of pages and so forth. In step 31(S31), the data acquisition unit 62 reads the compressed baseline data from the data stored in the baseline data storing unit 64, and decompress the compressed baseline data.

In step 32 (S32), the data acquisition unit 62 stores the baseline data in the temporary data storing unit 63. On the other hand, the data acquisition unit 62 sets a read completion flag to indicate that the baseline data corresponding to the N-th page of the reference printed copy has been read.

In step 34 (S34), the data acquisition unit 62 determines whether or not the baseline data has been completely read through the final page. This determination is done by checking the read completion flags. If the determination is in the affirmative in step 34, the process proceeds to step 35 (S35). Conversely, if the determination is in the negative in step 34, the process of this routine is returned to step 31 in which the baseline data is read for the next remaining page.

In step 35, the data acquisition unit 62 reads the compressed differential image data from the differential data storing unit 66, decompresses the compressed differential image data, and stores the decompressed differential image data in the temporary data storing unit 63.

In step 36 (S36), the quality index calculating unit 67 calculates the quality index of the current print image by the use of the decompressed differential image data. The calculated quality index is output to the quality evaluating unit 68.

In step 37(S37), the quality evaluating unit 68 acquires the quality reference value from the reference value setting unit 69, and evaluates whether or not the print image quality is acceptable. If the quality index of the print image is lower than the quality reference value, the quality evaluating unit 68 determines that there is no problem in quality and that the print image quality of the printed sheet is acceptable. Conversely, if the quality index of the print image is no lower than the quality reference value, the quality evaluating unit 68 determines that there is a problem in quality and that the print image quality of the printed sheet is not acceptable, and the process proceeds to in step 38(S38).

In step 38 (S38), as has been discussed in conjunction with the second embodiment, the print control unit 61 performs error handling, i.e., (1) notification to user, (2) print cancellation, (3) print recovery, (4) image quality adjustment and so forth.

In step 39 (S39), the data acquisition unit 62 determines whether or not there is differential image data corresponding to the next page. If the determination is in the affirmative in step 39, this routine returns control. Conversely, if the determination is in the negative in step 39, the process returns to step 35 in which the differential image data is read for the next remaining page.

In the case of the present embodiment as described above, the evaluation of print image quality is performed when displaying the print image of the printed sheet. It is therefore possible to reduce the processing load when reading a printed sheet by deferring the evaluation of print image quality until a user instructs the system to display the print image. Incidentally, if such an areas that includes the copy number is excluded from the evaluation, information about this area is included in the information to be stored in associated with the differential image data.

### Fifth Embodiment

In what follows, an image forming apparatus 1 according to the fifth embodiment will be explained. The image forming apparatus 1 of the fifth embodiment differs from that of the first embodiment in that the print image reading unit 40 selectively reads the sheet P passing therethrough. Meanwhile, the second embodiment will be explained mainly with respect to the differences from the first embodiment without repeating redundant description.

What a user wants to get as information is the print result of print data the user designates. The sheets P conveyed in the image forming apparatus 1 may include an index sheet for taking into the final bookbinding layout, or a sample sheet for evaluating an image. A user rarely reviews the print image read from such sheets P again. Namely, the amount of data can be reduced by excluding a printed sheet from the subject of the reading operation if the printed sheet is not designated by a user to be printed. The print image reading unit 40 therefore performs the process in step 10 of the first embodiment in a modified manner as follows.

First, the print image reading unit 40 acquires printed copy information from the print control unit 61 to read the image printed on a sheet P (print image). The printed copy information according to the present embodiment further includes print data identification information which identifies the print data of an image to be formed on the sheet P. The print data identification information is not generated when the printed sheet is not designated by a user, for example, an index sheet or a sample sheet. Alternatively, specific identification information may be given to an index sheet, a sample sheet or the like sheet.

The print image reading unit 40 then determines whether or not there is identification information in the printed copy information by referring to the printed copy information. When there is identification information, the print image reading unit 40 reads a print image of one page to generate print image data. Conversely, there is no identification information, the print image reading unit 40 skips the reading and generating steps and determines whether or not the fixing unit 30 outputs a next sheet by interrogating the print control unit 61.

In accordance with the present embodiment as described above, the above types of printed sheet are excluded from the subject of the reading operation to inhibit the situation that the amount of data is unnecessarily increased.

Incidentally, while the print image reading unit 40 does preferably not read a printed sheet which is not designated by a user, it is also possible to reduce the amount of data, for example, by excluding the printed sheet from the subject of the differential print image data generating operation after reading the printed sheet, or excluding the printed sheet from the subject of the data storing operation after generating differential image data. Furthermore, when the paper jam occurs, sheets P remaining in the conveying route of the image forming apparatus 1 are discarded so that these sheets P are preferably excluded from the subject of further processes.

### Sixth Embodiment

In what follows, an image forming apparatus 1 according to the sixth embodiment will be explained. The image forming apparatus 1 of the sixth embodiment differs from that of the first embodiment in that, when the same printed material is printed again, the previous baseline data is reutilized. Meanwhile, the sixth embodiment will be explained mainly with respect to the differences from the first embodiment without repeating redundant description.

When additional copies are printed for example for re-publishing, the same print data is used so that the previous baseline data can be reutilized with no problem. By this configuration, when the reprint is repeated, it is possible to reduce the amount of data required for storing the baseline data. The print image reading unit 40 therefore performs the process in step 10 through step 12 of the first embodiment in a modified manner as follows.

First, the print image reading unit 40 acquires printed copy information from the print control unit 61 to read the image printed on a printed sheet (print image). The printed copy information according to the present embodiment further includes print data identification information which identifies the print data of an image to be formed on the printed sheet, and a reprint flag which indicates if the print job is a reprint job.

The print image reading unit 40 then reads the print image of the printed sheet and generates the print image data containing one-page information. The data acquisition unit 62 acquires the print image data, the page information and the copy information from the print image reading unit 40, and stores these data and information in the temporary data storing unit 63.

The data acquisition unit 62 then refers to the printed copy information to confirm whether or not the print job is a reprint job, i.e., whether or not the reprint flags is set in the printed copy information. If the print job is a reprint job, the baseline data is to be read. This step is performed only once just after reading the first page of the first copy for each print job.

The data acquisition unit 62 refers to the print data identification information contained in the printed copy information, and reads the compressed baseline data from the baseline data storing unit 64 together with the print data identification information. Then, the data acquisition unit 62 decompresses the compressed baseline data, and stores the decompressed baseline data in the temporary data storing unit 63.

In accordance with the present embodiment as described above, when the reprint is repeated, it is possible to reduce the amount of data required for storing the baseline data. However, even when the print job is a reprint job, it is preferred to treat the reprint job as a new print job if a print setting such as the type of paper, image density or the like has been changed.

The foregoing description has been presented on the basis of the image forming apparatus and the image processing method according to the embodiments of the present invention. However, it is not intended to limit the present invention to the precise form described, and obviously many modifications and variations are possible within the scope of the invention.

While a storage means is provided within the image forming apparatus for storing data in accordance with the embodiments as described above, such a storage means may be implemented within an external computer or the like but need not be located in the image forming apparatus itself. Also, while the image forming apparatus is provided with the print image reading unit in accordance with the embodiments as described above, a dedicated reading unit may be provided and located in the subsequent stage to the image forming apparatus such that the dedicated reading unit serves to read printed sheets and store read data. The image forming apparatus provided with such a dedicated reading unit serves as an embodiment of the present invention. Furthermore, the image forming system does not necessarily consist of a plurality of separate apparatuses, but may be constructed as a single image forming apparatus within which are implemented the functions of forming images, reading print images, storing data and so forth as has been discussed above.

What is claimed is:

1. an image processing method comprising:
a first step of forming an image on a sheet on the basis of a print job including information about a printed material consisting of a predetermined number of pages and the number of copies to be printed;
a second step of reading the image formed on the sheet and generating print image data;
a third step of acquiring, as baseline data, print image data of each page of a printed copy which is one of a plurality of the printed copies and to be used as a reference; and
a fourth step of acquiring print image data of each page of a printed copy other than the printed copy that is to be used as the reference, comparing the print image data acquired in this fourth step with the baseline data for each page, and generating differential information therebetween.

2. The image processing method of claim 1 further comprising:
a fifth step of calculating a quality index which is used as an index of the print image quality of a printed sheet on the basis of said differential information; and
a sixth step of comparing the calculated quality index with a reference value, and determining if the print image quality of the printed sheet is acceptable.

3. The image processing method of claim 2 further comprising:
a seventh step of performing, when it is determined that the print image quality of the printed sheet is not acceptable, at least one of processes of notifying a user of a warning, cancelling image formation, retrying printing, and performing an image quality stabilization process for maintaining the image quality of image formation to an appropriate level.

4. The image processing method of claim 2 wherein
the differential information for calculating the quality index in said fifth step is generated by extracting a partial area from the image area corresponding to the print image data.

5. The image processing method of claim 2 wherein
the resolution of the differential information is changed in said fourth step in accordance with the quality index calculated in said fifth step.

6. The image processing method of claim 1 further comprising
an eighth step of displaying the differential information.

7. The image processing method of claim 1 wherein
the differential information is calculated in said fourth step by extracting a partial area from the image area corresponding to the print image data.

8. The image processing method of claim 1 wherein
said second step includes a step of acquiring printed copy information indicative of information about the printed copy which is the subject of reading operation, and determining whether to read the image on the basis of the acquired printed copy information.

9. The image processing method of claim 1 wherein
said fourth step includes a step of acquiring printed copy information indicative of information about the printed copy which is the subject of reading operation, and determining whether to generate the differential information on the basis of the acquired printed copy information.

10. The image processing method of claim 1 wherein
said third step includes a step of storing the acquired baseline data in a storage area, and wherein
said fourth step includes a step of storing the generated differential information in a storage area.

11. The image processing method of claim 10 wherein
said fourth step includes a step of acquiring printed copy information indicative of information about the printed copy which is the subject of reading operation, and determining whether to store the differential information in said storage area on the basis of the acquired printed copy information.

12. The image processing method of claim 10 wherein
the differential information is stored in said storage area in said fourth step together with identification information which identifies print data, and wherein
when it is determined that the print job is a reprint job, the data stored in said storage area is used as the baseline data.

13. The image processing method of claim 10 wherein
in the fourth step, the differential information of the printed copies corresponding to each page is stored in one data block, or the differential information corresponding to all the pages of each copy is stored in one data block.

14. An image forming apparatus comprising:
an image forming unit configured to form an image on a sheet on the basis of a print job including information about a printed material consisting of a predetermined number of pages and the number of copies to be printed;
a print image reading unit configured to read the image formed on the sheet which is output from said image forming unit and generate print image data;
a data acquisition unit configured to acquire the print image data of each copy for each page of the printed material;
a differential data generating unit configured to compare, for each page, baseline data which is print image data of a printed copy which is one of a plurality of the printed copies and to be used as a reference, with print image data of a printed copy other than the printed copy that is to be used as the reference to generate differential information therebetween.

15. The image forming apparatus of claim 14 further comprising:
a quality index calculating unit configured to calculate a quality index which is used as an index of the print image quality of a printed sheet on the basis of said differential information; and
a determination unit configured to compare the calculated quality index with a reference value, and determine if the print image quality of the printed sheet is acceptable.

16. The image forming apparatus of claim 14 wherein
the differential information for calculating the quality index is generated by extracting a partial area from the image area corresponding to the print image data.

17. The image forming apparatus of claim 14 wherein
said differential data generating unit changes the resolution of the differential information in accordance with the quality index calculated by said quality index calculating unit.

18. The image forming apparatus of claim 14 wherein
said differential data generating unit calculates the differential information by extracting a partial area from the image area corresponding to the print image data.

19. An image forming system comprising:
an image forming unit configured to form an image on a sheet on the basis of a print job including information about a printed material consisting of a predetermined number of pages and the number of copies to be printed;
a print image reading unit configured to read the image formed on the sheet which is output from said image forming unit and generate print image data;
a data acquisition unit configured to acquire the print image data of each copy for each page of the printed material;
a baseline data storing unit configured to store, as baseline data, print image data of each page of a printed copy which is one of a plurality of the printed copies and to be used as a reference;
a differential data generating unit configured to acquire print image data of each page of a printed copy other than the printed copy that is to be used as the reference, compare the acquired print image data with the baseline data for each page, and generate differential information therebetween; and
a differential data storing unit configured to store the generated differential information.
